(19) United States
(12) Patent Application Publication
(10) Pub. No.: US 2007/0029939 A1
(43) Pub. Date: Feb. 8, 2007

(54) Electroluminescent sign having a coded information region

(76) Inventors: Philip Burkum, Corvallis, OR (US); Darrel E. Pozzesi, Corvallis, OR (US); Luis Aldarondo, Corvallis, OR (US); Terry M. Lambright, Corvallis, OR (US); Sterling Chaffins, Albany, OR (US); Daniel W. Youngberg, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/198,101

(22) Filed: Aug. 5, 2005

(51) Int. Cl. H05B 37/00

(52) U.S. Cl. 315/86

(57) ABSTRACT

An electroluminescent sign and a method for selectively illuminating such an electroluminescent sign is disclosed. The method can include steps of creating an electroluminescent sign having an electroluminescent region and a coded information region, the coded information region providing instructions to illuminate the electroluminescent region. The method can further include steps of reading the coded information region to obtain the instructions, and selectively illuminating the electroluminescent region according to the instructions provided by the coded information region.

### FIELD OF THE INVENTION

The present invention relates generally to the creation and illumination of electroluminescent signs. More particularly, the present invention relates to using coded information to drive electroluminescent signs.

### BACKGROUND OF THE INVENTION

Electroluminescence is a source of illumination that has become widely used in many applications. Electroluminescent Illumination can be produced by applying electrical energy to a luminescent material. The luminescent material is often associated with an electrode or other substrate in a specific pattern in order to produce a specific pattern of illumination. As such, electroluminescence can be used in connection with signs where illumination is desired.

Electroluminescence devices are generally of simple construction and are thus manufactured at a relatively low cost compared to other illumination sources. Electroluminescent devices also require relatively little power to produce luminescence, and thus typically generate a low amount of heat. Because of the low construction and operating costs, electroluminescent signs are becoming even more widely used in many applications.

There are aspects of electroluminescent sign manufacture, however, that increase costs and thus limits many of the potential uses of this technology. For example, the illumination pattern of each electroluminescent sign design must be analyzed and the underlying electronic circuitry must be customized by a technical expert in order to generate the desired illumination. Such analysis and customization may be a costly and time consuming procedure, which can increase manufacturing costs and thus limit the use of electroluminescence technology for many applications. For example, the low manufacturing costs of electroluminescent signs make them ideal for applications where the sign is intended to be disposable. Technical customization can increase costs and thus preclude the use of electroluminescent signs as disposable articles, especially in situations where the illumination patterns of the disposable signs are frequently altered.

As such, methods and devices are continually being sought to facilitate the increased use of electroluminescence illumination devices.

### BRIEF DESCRIPTION OF THE DRAWINGS

FIG. 1 is a schematic cross-sectional view of a portion of an electroluminescent device in accordance with an embodiment of the present invention; and

FIG. 2 is a schematic plan view of an electroluminescent device in accordance with an embodiment of the present invention.

### DETAILED DESCRIPTION OF THE PREFERRED EMBODIMENT(S)

Reference will now be made to the exemplary embodiments of the present invention, both those described and those illustrated in the drawing, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In describing and claiming the present invention, the following terminology will be used.

The singular forms “a,” “an,” and “the” include plural referents unless the context clearly dictates otherwise. Thus, for example, reference to “an electrode” includes reference to one or more electrodes.

The term “pattern” refers to a design or configuration of lighted portions of an electroluminescent sign. The pattern can include lit and unlit areas, including areas having various levels of illumination. The pattern can include spatial patterns and/or temporal patterns.

As used herein, the term “spatial pattern” refers to a pattern that is distributed in physical space. Though a particular pattern may have temporal characteristics, the spatial portions of the pattern are defined by the locations of the various lit and unlit regions.

The term “temporal pattern” refers to a pattern that varies over time. In other words, the pattern of an electroluminescent region having temporal characteristics changes over time. This may include flashing regions, dimming regions, brightening regions, regions of changing color, etc. Though a particular pattern will necessarily have spatial characteristics, the temporal portions of the pattern are defined by the variations of the pattern over time.

As used herein, “luminescence” and “illumination” may be used interchangeably, and refer to the generation of light. It is intended that these terms include light generated from any non-thermal source, including fluorescence and phosphorescence.

The term “about” when referring to a numerical value or range is intended to encompass the values resulting from experimental error that can occur when taking measurements.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

According to various aspects of the present invention, an electroluminescent sign can be conveniently driven by using standard illumination instructions in coded information located on the sign and with standard drivers made to control such custom signs with a variety of illumination choices. Such standardization can allow computer programs to analyze custom designed illuminated areas and illumination preferences, and thus eliminate the costly expense of individual sign design customization by a technical expert. A computer program can use engineering parameters to calculate driver parameter settings, and incorporate the coded information into the sign that a coded information reader can read. Thus such technical experts are only required to create the program, not to customize each individual sign design. Also, software analysis and coding of lighting requirements can be automatically utilized by a driver upon standard connection to an electroluminescent sign. As such, a user need only connect the customized electroluminescent sign to such a standard connection and it will function as intended.

In accordance with the present invention, one aspect provides a method for selectively illuminating an electroluminescent sign. The method can include the steps of creating an electroluminescent sign having an electroluminescent region and a coded information region, where the coded information region providing instructions to illuminate the electroluminescent region. The method can further include steps of reading the coded information region to obtain the instructions and selectively illuminating the electroluminescent region according to the instructions provided by the coded information region.

In another aspect, an electroluminescent sign is provided. The electroluminescent sign can include an electroluminescent region including an electroluminescent material and a coded information region integral to the electroluminescent sign, the coded information region containing instructions for selectively illuminating at least a portion of the electroluminescent material. The electroluminescent material may be deposited onto a substrate to form the electroluminescent region, or the electroluminescent region can be comprised of predominantly electroluminescent material.

Various substrate materials are known to those of ordinary skill in the art, and all are considered to be within the scope of the present invention. In one aspect, the substrate may be an electrode material and thus become a permanent component to the electroluminescent sign. Other permanent substrates are contemplated, including those substrates that are intended to provide a permanent support for the electroluminescent material and electrode materials. In another aspect, the substrate may be a temporary support used to manufacture and/or transport the electroluminescent sign. For example, the electroluminescent material can be applied to a substrate surface that provides support during manufacture. The electroluminescent sign can be removed from the substrate upon completion of the manufacturing process or following transport to a location where the sign is to be used.

Numerous means of applying an electroluminescent material can be utilized in the manufacture of the signs of the present invention. In some cases, the means of application may vary depending on the nature of the electroluminescent material. It is understood that electroluminescent materials and associated manufacturing techniques that are currently known can be implemented for use in accordance with embodiments of the present invention. For example, an electroluminescent material can be applied to a substrate by spraying; knife coating; printing; dipping; painting; silk-screening; thin film electroluminescent methods such as sputtering, chemical vapor deposition, etc; and combinations thereof.

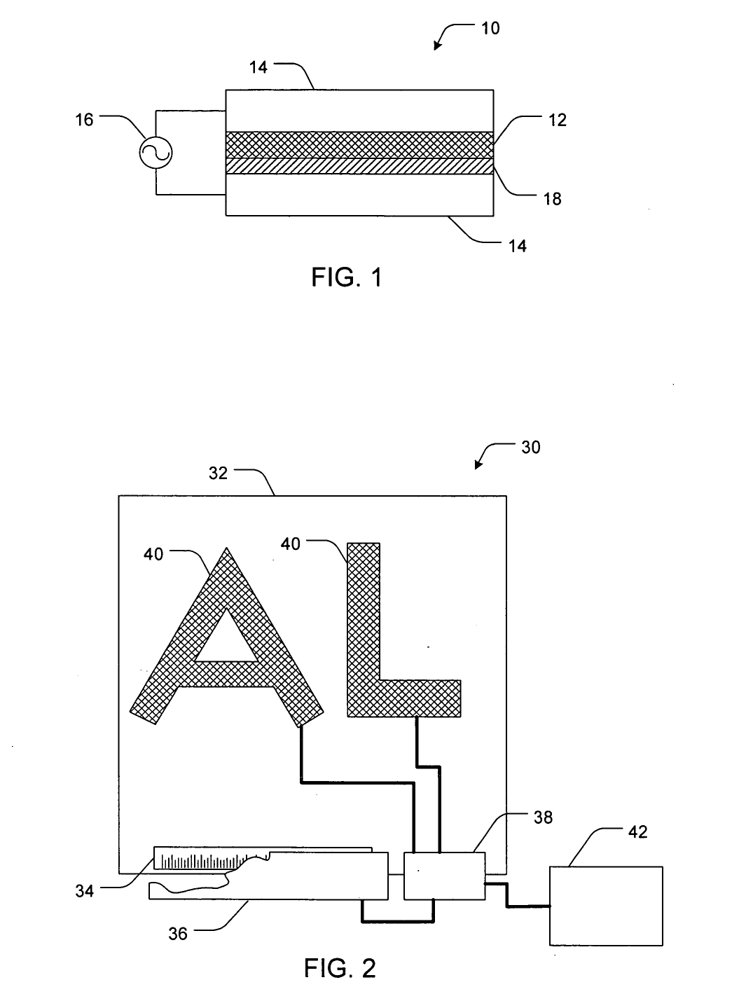

Turning to FIG. 1, an example of a specific embodiment of an electroluminescent sign 10 is provided. It is intended that the “sandwich” design shown in FIG. 1 not be limiting and that numerous physical configurations of the components of the electroluminescent sign are possible. As such, the electroluminescent sign can include a layer of an electroluminescent material 12 disposed between a pair of electrodes 14. Electroluminescent materials that are currently known in the art are suitable for use in constructing the electroluminescent sign, and as such, any material that emits measurable light in the presence of electrical energy can be utilized in the embodiments of the present invention. For example, the electroluminescence can include fluorescence and/or phosphorescence. In one aspect, the luminescent material can be a carrier including a dopant ion. Though various materials can be utilized as carriers, specific examples include, without limitation, zinc sulfide, zinc oxide, yittrium aluminum oxide, quartz, olivine, pyroxene, amphiborite, mica, pyrophillite, mullite, garnet, AlN and mixtures thereof. Also, though various materials can be utilized as dopant ions, specific examples include, without limitation, Cu, Ag, Mn, Fe, Ni, Co, Ti, V, Cr, Zr, and mixtures thereof. As such, dopant ions are co-crystallized into a carrier lattice whereby the dopant ions generate illumination. In one aspect, the luminescent material can be copper ions co-crystallized in a zinc sulfide lattice. In another aspect, the luminescent material can be copper ions co-crystallized in a zinc oxide lattice. An oxide carrier material may be more stable at higher temperatures than a sulfide carrier, and may thus reduce aging problems associated with the luminescent material. However, both are effective for use.

It is intended that reference to a pair of electrodes not be limiting in any way as to the number of electrodes included in an electroluminescent sign. For example, a pair of electrodes may include a single electrode that is folded to enclose an electroluminescent material. Similarly, embodiments are contemplated in which more than two electrodes are included. As such, “pair of electrodes” does not necessarily refer to the number of electrodes, but merely a spatial description of electrode surfaces physically positioned on multiple sides with respect to an electroluminescent material.

Various materials for constructing the electrodes 14 are known to those skilled in the art, all of which are considered to be within the scope of the present invention. The materials from which different electrodes are made can be the same or different, depending on the intended use of the electroluminescent sign and/or the suitability of particular materials for a particular task. Any material that can be utilized to conduct electrical energy is considered to be suitable for use in constructing an electrode or an electrode layer. In one aspect of the present invention, at least one of the pair of electrodes can be configured to be at least partially transparent, and thus to transmit light. One example of such an electrode can be constructed of a transparent material coated with indium tin oxide. The transparent material can be any transparent material known, such as a glass, or a polymer such as a plastic. In those embodiments having only a single transparent electrode, luminescence generated in the electroluminescent material is transmitted through the single transparent electrode. In aspects wherein both of the pair of electrodes are transparent, luminescence will be transmitted through both sides of the sign or a particular section of the sign. This configuration may be useful where luminescence from both sides of the electroluminescent sign is desirable, i.e., where the sign may be viewed from both sides. The pair of electrodes can be of any shape or configuration that may be of use in the various embodiments of the present invention. In one aspect, the electrode pair can be planar. In another aspect, the electrode pair can be stiff or rigid. In yet another aspect, the electrode pair can be flexible.

The electroluminescent sign 10 can be illuminated by any means known to one skilled in the art. In one aspect, the electroluminescent sign is configured to receive electrical energy from a power source 16. The power source can be any type of power source known to one skilled in the art that can be used to power an electroluminescent sign. The power source can be integral to the electroluminescent sign or it can be a separate component to be later coupled thereto. The electrode pair 14 can be configured to receive electrical energy, and as such, the electroluminescent material and the electrodes are configured such that at least a portion of the electroluminescent material 12 luminesces when the electrical energy is applied across the pair of electrodes. The electrical energy can thus cause at least a portion of the electroluminescent region to selectively luminesce. In one aspect, such selective illumination can include illumination of the electroluminescent region in a predetermined spatial illumination pattern. Such spatial illumination can include, without limitation, words, symbols, patterns, diagrams, etc. In another aspect, such selective illumination can include illumination of the electroluminescent region in a predetermined temporal illumination pattern. Such temporal illumination patterns can include, without limitation, blinking, fading, brightening, etc.

In one aspect, the electroluminescent sign 10 can optionally include an insulating layer of a dielectric material 18. Such an insulating layer can also be disposed between the pair of electrodes 14. Additionally, multiple insulating layers can be incorporated into the electroluminescent sign to accomplish specific effects, to improve illumination, or to improve the durability of the sign or the electroluminescent material. The dielectric material can be any dielectric material known to one of ordinary skill in the art, including polymers, glasses, ceramics, inorganic compounds, organic compounds, or mixtures thereof. Examples can include, without limitation, BaTiO₃, PZT, Ta₂O₃, PET, PbZrO₃, PbTiO₃, NaCl, LiF, MgO, TiO₂, Al₂O₃, BaO, KCl, Mg₂SO₄, fused silica glass, soda lime silica glass, high lead glass, and mixtures or combinations thereof. In one aspect, the dielectric material can be BaTiO₃. In another aspect, the dielectric material can be PZT (lead zirconate titanate). In another aspect, the dielectric material can be PbZrO₃. In yet another aspect, the dielectric material can be PbTiO₃.

The thickness of the insulating layer 18 can be any thickness that allows the generation of luminescence in accordance with various aspects of the present invention. In one aspect, the insulating layer can be from about 1 μm to about 500 μm thick. In another aspect, the insulating layer can be from about 4 μm to about 100 μm thick. In yet another aspect, the insulating layer can be from about 4 μm to about 30 μm thick.

As is shown in FIG. 2, an electroluminescent sign 32 in accordance with an embodiment of the present invention can also be incorporated into an electroluminescent sign system 30. As such, much of the discussion herein relating to electroluminescent signs incorporated into sign systems also applies to the electroluminescent signs themselves. The electroluminescent sign system can include an electroluminescent sign 32 having an electroluminescent region 40 and a coded information region 34, the coded information region containing instructions to illuminate the electroluminescent region. The system can also include a coded information reader 36 that is configured to read the coded information region to obtain the instructions. Additionally, a driver 38 can be functionally coupled to the coded information reader. The driver can be configured to selectively illuminate at least a portion of the electroluminescent region according to the instructions received from the coded information reader. The letters “A” and “L” in FIG. 2 show examples of electroluminescent regions that can be selectively illuminated. A power supply 42 can be functionally coupled to the driver and to the electroluminescent region, and can be configured to provide power to the electroluminescent region.

The coded information region 34 can contain instructions to illuminate the electroluminescent region 40 of the electroluminescent sign 32. As such, a technical expert need not customize each individual sign design. The coded information region and the associated instructions can be generated by any means known to one skilled in the art. In one aspect, the desired illumination characteristics of an electroluminescent sign can be input into a computer program which generates the instructions for the coded information region. The electroluminescent sign can then be associated with a coded information reader 36 capable of reading the coded information region to obtain the instructions, and to a driver 38 capable of receiving the instructions from the coded information reader and illuminating the sign accordingly. The generation of such a computer program is considered to be well within the knowledge of one skilled in the art, and thus details of such are not provided herein.

It is intended that any type of illumination instructions provided by the coded information region be within the scope of the present invention. It should be understood that any type of illumination pattern can be reduced to illumination instructions and incorporated into the coded information region of an electroluminescent sign. In one aspect, the coded information region can provide instructions for illuminating the electroluminescent sign according to a predetermined spatial pattern. The spatial pattern can include, without limitation, lit and unlit areas, areas of varied illumination levels, areas of varied colors, etc. These spatial patterns can be words, symbols, trademarks, patterns, diagrams, random illumination, etc. In another aspect, the coded information region can provide instructions for illuminating the electroluminescent sign according to a predetermined temporal pattern. The temporal pattern can include, without limitation, blinking regions, fading regions, brightening regions, etc. In yet another aspect, the coded information region can provide instructions for illuminating the electroluminescent sign according to a predetermined spatial pattern and a predetermined temporal pattern.

Any type of coded information capable of containing the illumination instructions and capable of being read by a coded information reader is considered to be within scope of the present invention. For example, the coded information can include a type of code such as optical codes, mechanical codes, electrical codes, magnetic codes, wireless codes, codes within attached devices, and combinations thereof.

In one aspect, the coded information region can contain an electrical code. Numerous types of electrical coded information are contemplated that can store and convey illumination instructions. In one aspect, the information contained in the electrical code can include a pattern of open circuits and short circuits. A coded information reader can read the pattern of open circuits and short circuits to obtain the illumination instructions. Electrical coded information involving bits defined as open circuits, short circuits, and/or varying resistances can be accomplished by patterning conductors on the electroluminescent sign that can be read by a coded information reader. Also, the resistance of materials on the sign can be varied to create such a readable pattern. One example of how to create such a readable pattern includes laser patterning to change the electrical characteristics of a laser-responsive material. Other examples may include oxidation of a conductive polymer, or any other means of electrical patterning known to one skilled in the art.

Such an electrical code can also be intrinsic to the electroluminescent sign or the electroluminescent region. In such situations, the coded information reader can read open circuits, short circuits, and/or resistivity of circuits within the circuitry of the sign itself to determine how the electroluminescent region should be illuminated. For example, the coded information reader can analyze the various energy draws for each circuit of the electroluminescent sign to determine which areas are to be illuminated. Limitations arise, however, when the illumination includes temporal patterns that may not be read simply from analyzing the energy draw of a circuit. In these cases, coded information can include such temporal pattern illumination instructions distinct from the sign circuitry.

In another aspect of the present invention, the coded information region can include a mechanically modified portion of the electroluminescent sign. The mechanically modified portion can include, without limitation, patterns of holes, embossed patterns, slot patterns, crimp patterns, or any other mechanical modification that can be read by a mechanical reader.

Aspects of the present invention also include optically coded information. Optically coded information can include any optically readable pattern known to one skilled in the art. Examples of optically readable patterns include barcodes, color patterns, text and microtext, microdots, etc.

In another aspect, the coded information region can include magnetically coded information. Various types of magnetically coded information are contemplated, including patterned magnetic materials, magnetic strips, or any other material that can be coded by writing with a magnetic field and read with a magnetic code reader. Magnetic strips may be highly beneficial where large numbers of electroluminescent signs are produced. In such cases, magnetic strips containing the illuminations instructions for the electroluminescent signs can be created in a continuous strip, cut into appropriate lengths, and coupled to each sign. The magnetic strip can be glued, laminated, or otherwise affixed to the electroluminescent sign in a position appropriate to allow reading by the magnetic code reader. One benefit to magnetic coding methods includes the ability to store large amounts of coded information in a relatively small area.

In yet another aspect of the present invention, wireless coding methods are contemplated. Such methods include custom-patterned, passive, resistive/capacitative circuits combined with an antenna. Such codes can be read by a radio frequency (RF) reader. Active RF coding can also be used, however a power supply associated with the RF coded information and more complex circuitry would most likely be required. One advantage of such wireless coded methods can include the ability to update or change the electroluminescent sign illumination patterns to optimize its performance in a particular environment after the sign has been installed.

In a further aspect, the coded information region can include coded information within an attached device. For example, the illumination instructions can be encoded in an IC chip or other logic/memory device with a writable memory. Such a device can be separately coupled to the electroluminescent sign, or it can be incorporated into the sign circuitry.

The coded information region can be created or incorporated into the electroluminescent sign at any time before, during, or after the sign's manufacture. In one aspect, the coded information region can be incorporated into the electroluminescent sign during the manufacturing process. This is particularly useful in situations where the coded information region is constructed of the same material as used in the construction of the electroluminescent sign, and can thus be printed/disposed simultaneously. In another aspect, the coded information region can be coupled to the sign before or after the manufacturing process. As such, the coded information region can be disposed directly onto the electroluminescent sign, or it can be affixed thereto. One example of the latter can include coded information printed onto an adhesive material which is affixed to the sign. Also, in yet another aspect, the coded information region and the electroluminescent region can be integral to the electroluminescent sign. In other words, the coded information region and the electroluminescent region can be a single article, rather than modular components.

The coded information readers 36 of the present invention can be any reader capable of reading the coded information region incorporated into the electroluminescent sign. Examples of specific types of coded information readers have been described herein in relation to specific types of code. It is considered that the workings of such readers are well within the knowledge of one skilled in the art, and that any means of reading a particular type of code be included within the scope of the present invention. In various aspects of the present invention, the coded information reader can be configured to read numerous types of codes, including, without limitation, optical codes, mechanical codes, electrical codes, magnetic codes, wireless codes, codes contained within attached devices, and combinations thereof.

The coded information reader 36 can be of a variety of configurations in relation to the electroluminescent sign. For example, the coded information reader can be physically coupled to a portion of the sign, abut the sign, enclose a portion of the sign, be in optical or wireless proximity to the sign, etc. In many cases the configuration and location of the coded information reader can depend on the type of code that is to be read. In one aspect of the present invention, the coded information reader can also include a structure that can provide at least partial physical support to the electroluminescent sign.

The driver 38 can be physically coupled to the coded information reader 36, or physically separated therefrom. The driver can be functionally coupled to the coded information reader in order to receive the illumination instructions from the coded information region 34 via the reader. Such functional coupling can include electrical coupling, wireless coupling, optical coupling, or any other functional coupling means known to one skilled in the art. The driver can also include appropriate circuitry, lookup tables, and/or any other components to be used in receiving, decoding and implementing the illumination instructions in the electroluminescent sign. The driver can also be electrically coupled to at least a portion of each of the pair of electrodes of the electroluminescent sign 32 and to the power supply 42. As such, the illumination instructions can be received, decoded, and electrical energy provided to the electroluminescent region 40 in an appropriate manner to cause proper illumination. Power supplies are well known to those skilled in the art, and can vary depending on the configuration of the electroluminescent sign.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. A method for selectively illuminating an electroluminescent sign, comprising steps of:
creating an electroluminescent sign having an electroluminescent region and a coded information region, the coded information region providing instructions to illuminate the electroluminescent region;
reading the coded information region to obtain the instructions; and
selectively illuminating the electroluminescent region according to the instructions provided by the coded information region.

2. The method of claim 1, wherein the step of creating the electroluminescent sign further includes applying an electroluminescent material to a substrate to form an electroluminescent region.

3. The method of claim 1, wherein the step of creating the electroluminescent sign further includes incorporating coded information into the electroluminescent sign to form the coded information region.

4. The method of claim 1, wherein the electroluminescent region and the coded information region are integral to the electroluminescent sign.

5. The method of claim 1, wherein the electroluminescent region and the coded information region are created concurrently.

6. The method of claim 1, wherein the coded information region is created either before or after creating the electroluminescent region.

7. The method of claim 1, further comprising a step of affixing the coded information region to the electroluminescent sign.

8. The method of claim 1, further including a step of creating a pattern of open circuits and short circuits to form the coded information region.

9. The method of claim 1, further including a step of mechanically modifying a portion of the electroluminescent sign to form the coded information region.

10. The method of claim 1, wherein the step of selectively illuminating the electroluminescent region includes illuminating the electroluminescent region in a predetermined spatial illumination pattern.

11. The method of claim 1, wherein the step of selectively illuminating the electroluminescent region includes illuminating the electroluminescent region in a predetermined temporal illumination pattern.

12. The method of claim 1, wherein the coded information region includes a type of code selected from the group consisting of optical codes, mechanical codes, electrical codes, magnetic codes, wireless codes, codes contained within attached devices, and combinations thereof.

13. An electroluminescent sign system, comprising:
an electroluminescent sign having an electroluminescent region and a coded information region, the coded information region containing instructions to illuminate the electroluminescent region;
a coded information reader configured to read the coded information region to obtain the instructions;
a driver functionally coupled to the coded information reader, the driver being configured to selectively illuminate at least a portion of the electroluminescent region according to the instructions received from the coded information reader; and
a power supply functionally coupled to the driver and to the electroluminescent sign, the power supply being configured to provide power to the electroluminescent region.

14. The electroluminescent sign system of claim 13, wherein the coded information reader is configured to read a type of code selected from the group consisting of optical codes, mechanical codes, electrical codes, magnetic codes, wireless codes, codes within attached devices, and combinations thereof.

15. The electroluminescent sign system of claim 13, wherein the electroluminescent sign is physically supported at least partially by the coded information reader.

16. The electroluminescent sign system of claim 13, wherein the electroluminescent region further includes a pair of electrodes having electroluminescent material disposed therebetween.

17. The electroluminescent sign system of claim 16, wherein the driver is electrically coupled to at least a portion of each of the pair of electrodes and to the power supply.

18. An electroluminescent sign, comprising:
an electroluminescent region including an electroluminescent material; and
a coded information region integral to the electroluminescent sign, the coded information region containing instructions for selectively illuminating at least a portion of the electroluminescent material.

19. The electroluminescent sign of claim 18, further comprising a pair of electrodes having the electroluminescent material disposed therebetween.

20. The electroluminescent sign of claim 19, wherein at least one of the pair of electrodes is at least partially transparent.

21. The electroluminescent sign of claim 19, wherein the pair of electrodes is configured to receive electrical energy, the electroluminescent material and the electrodes being configured such that at least a portion of the electroluminescent material luminesces when the electrical energy is applied across the pair of electrodes.

22. The electroluminescent sign of claim 18, further comprising a dielectric material disposed between the pair of electrodes.

23. The electroluminescent sign of claim 18, wherein the coded information region is configured to be read by a coded information reader.

24. The electroluminescent sign of claim 18, wherein the coded information region includes a type of code selected from the group consisting of optical codes, mechanical codes, electrical codes, magnetic codes, wireless codes, codes within attached devices, and combinations thereof.

25. The electroluminescent sign of claim 18, wherein the coded information region contains instructions for illuminating the electroluminescent sign according to a predetermined spatial pattern.

26. The electroluminescent sign of claim 18, wherein the coded information region contains instructions for illuminating the electroluminescent sign according to a predetermined temporal pattern.

27. An electroluminescent sign, comprising:
an electroluminescent region including an electroluminescent material; and
a means for providing instructions for selectively illuminating at least a portion of the electroluminescent material, the means for providing instructions being coupled to the electroluminescent sign.
